(19) United States
(12) Patent Application Publication
(10) Pub. No.: US 2012/0019087 A1
(43) Pub. Date: Jan. 26, 2012

(54) Magnetic Electron Exciter and Methods

(76) Inventor: Johnnie L. Jones, Pierson, MI (US)

(21) Appl. No.: 13/187,004

(22) Filed: Jul. 20, 2011

Related U.S. Application Data
(60) Provisional application No. 61/365,879, filed on Jul. 20, 2010.

(51) Int. Cl. H02K 49/10

(52) U.S. Cl. 310/93

(57) ABSTRACT

A magnetic electron exciter includes a rotor adapted to be rotated within a selected range of rotational speeds, and having a plurality of magnets mounted therein selected distances from the rotational axis of the rotor. A plurality of coils are positioned adjacent to the rotor, whereby rotation of the rotor creates an electrical current in the coils. First and second electrodes are spaced apart a determined distance, and are electrically connected with the coils to create an arc between the electrodes when the rotor is rotated relative to the coils. The magnetic electron exciter can be used as a non-contact brake for machines, such as motor vehicles, wind turbines and the like.

### CROSS-REFERENCE TO RELATED APPLICATIONS

This application claims the benefit of U.S. Provisional Application No. 61/365,879, entitled MAGNETIC ELECTRON EXCITER AND METHODS, filed on Jul. 20, 2010 the entire contents of which is incorporated herein by reference.

### BACKGROUND OF THE INVENTION

The present invention relates generally to electrical generators, brakes and the like, and in particular to a magnetic electron exciter and associated processes using the same.

### SUMMARY OF THE INVENTION

One aspect of the present invention is to provide a magnetic electron exciter having a rotor adapted to be rotated within a selected range of rotational speeds, and a plurality of magnets mounted in the rotor selected distances from the rotational axis of the rotor. A plurality of coils are disposed adjacent to the rotor, whereby rotation of the rotor creates an electrical current in the coils. First and second electrodes are spaced apart a variable distance, and are electrically connected with the coils to create an arc between the electrodes when the rotor is rotated relative to the coils. Also, the positions of the coils can be angularly adjusted whereby the device can be utilized as an electric motor.

Another aspect of the present invention is a brake for machines and the like, such as motor vehicles, wind turbines, etc., having a rotor operably connected with the drive shaft of the machine for rotation within a selected range of rotational speeds, and a plurality of magnets mounted in the rotor selected distances from the rotational axis of the rotor. A plurality of coils are disposed adjacent to the rotor, whereby rotation of the rotor creates an electrical current in the coils. Upon deceleration of the machine, the magnetic electron exciter is actuated to decelerate the machine, and simultaneously create electrical energy.

Yet another aspect of the present invention is a method for processing materials, comprising forming a rotor adapted to be rotated within a selected range of rotational speeds, and mounting a plurality of magnets in the rotor at selected distances from the rotational axis of the rotor. The method further includes mounting a plurality of coils adjacent to the rotor, whereby rotation of the rotor creates an electrical current in the coils. The method further includes positioning first and second electrodes a spaced apart distance and electrically connecting the same with the coils. Finally, the method includes rotating the rotor relative to the coils to create an arc between the electrodes when the same is rotated relative to the coils, and positioning a material adjacent to or within the arc to process the same.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of a magnetic electron exciter embodying the present invention.

FIG. 2 is another perspective view of the magnetic electron exciter.

FIG. 3A is an exploded perspective view of a portion of the magnetic electron exciter.

FIG. 3B is a perspective view of a portion of the magnetic electron exciter.

FIG. 4 is a perspective view of a condenser portion of the magnetic electron exciter.

FIG. 5 is a perspective view of a rotor portion and a coil portion of the magnetic electron exciter.

FIG. 6A is a plan view of the rotor.

FIG. 6B is a perspective view of the rotor.

FIG. 7A is a plan view of a laminate portion of the magnetic electron exciter.

FIG. 7B is a perspective view of the laminate.

FIG. 7C is a side elevational view of the laminate.

FIG. 8 is a perspective view of the magnetic electron exciter showing a white light formed between opposite electrodes.

FIGS. 9 and 10 are perspective views of another embodiment of the magnetic electron exciter.

FIG. 11 is a partially schematic front elevational view of a magnetic electron exciter wherein the positions of the coils can be adjusted.

FIG. 12 is a fragmentary, exploded isometric view of a portion of the magnetic electron exciter.

### DETAILED DESCRIPT OF THE PREFERRED EMBODIMENTS

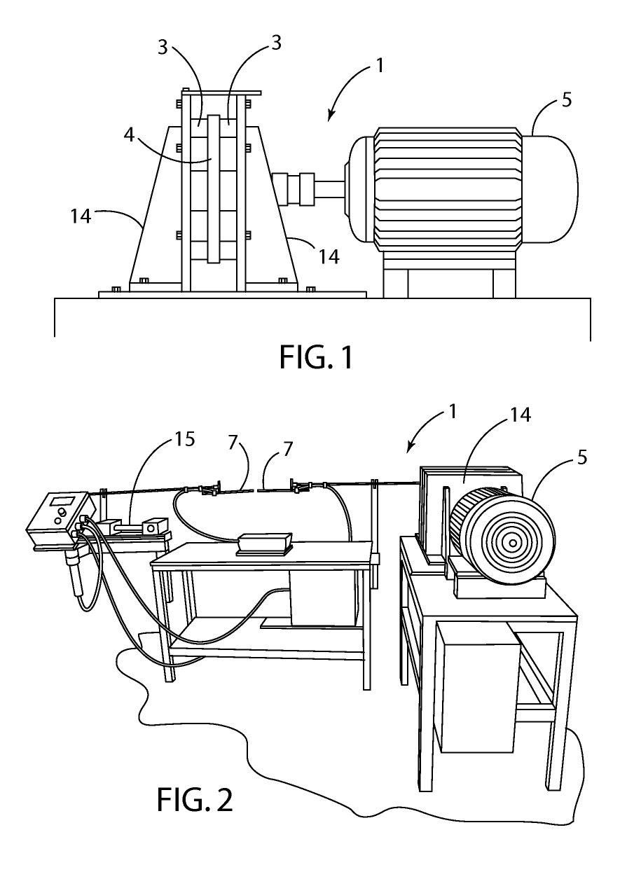

For purposes of description herein, the term “upper”, “lower”, “right”, “left”, “rear”, “front”, “vertical”, “horizontal” and derivatives thereof shall relate to the invention as shown in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts set forth herein. Hence, specific dimensions and other physical characteristics relating to the embodiments disclosed herein are not to be considered as limiting.

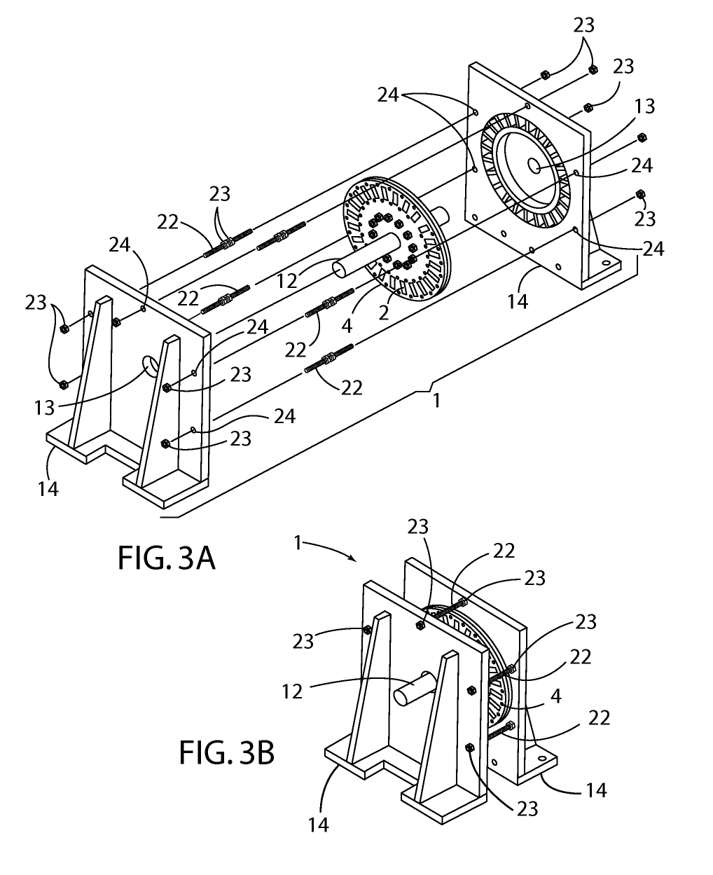

The reference numeral 1 (FIG. 1) generally designates a magnetic electron exciter (MEE) embodying the present invention. MEE 1 is a device that uses permanent magnets 2 (FIG. 3A) that are mounted on a rotor 4, and stationary electromagnetic coils 3. A rotor 4 includes a shaft 12 that rotatably engages openings/bearings 13 in brackets 14. When assembled, threaded rods 22 extend through openings 24 in brackets 14, and threaded nuts engage threaded rods 22 to support the brackets 14 at a desired spacing relative to rotor 4 and relative to one another. The permanent magnets 2 are fitted in a rotor 4 with north and south poles positioned in such a way as to cause them to come over the coils 3 on each side as the rotor 4 is turned by a motor 5 at various RPMs. As this is done, the faster the motor 5 turns the rotor 4, the more the permanent magnets 2 excite the electromagnetic coils 3, the more electrons are excited, and thus more energy is produced.

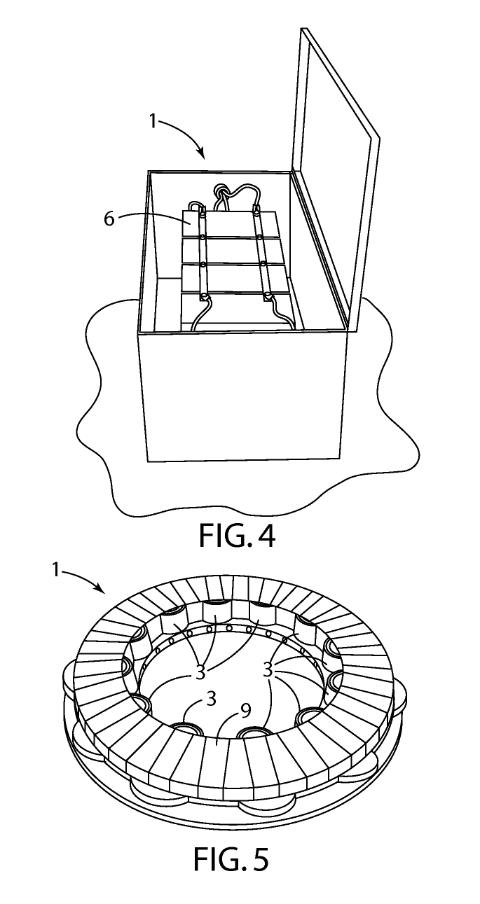

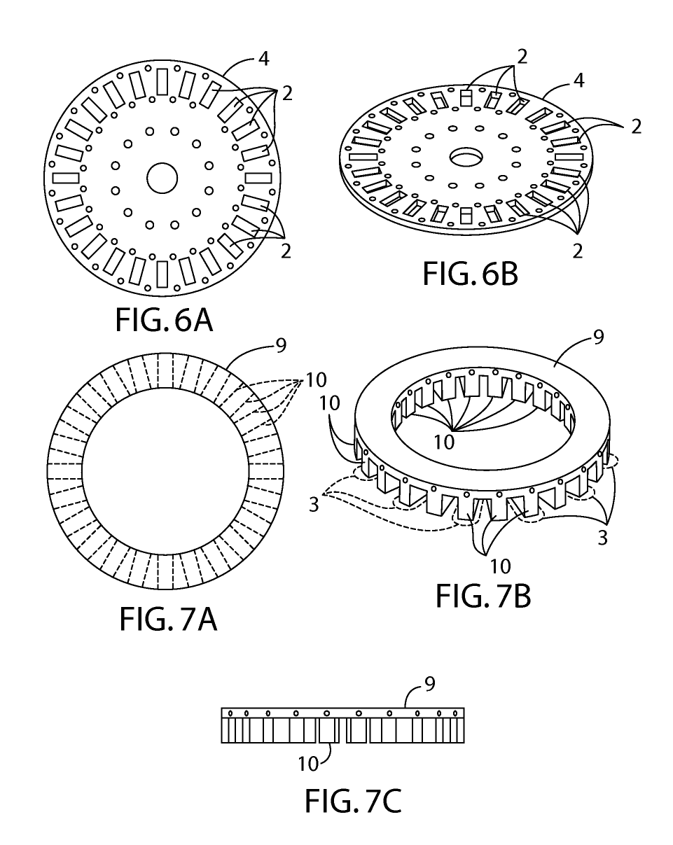

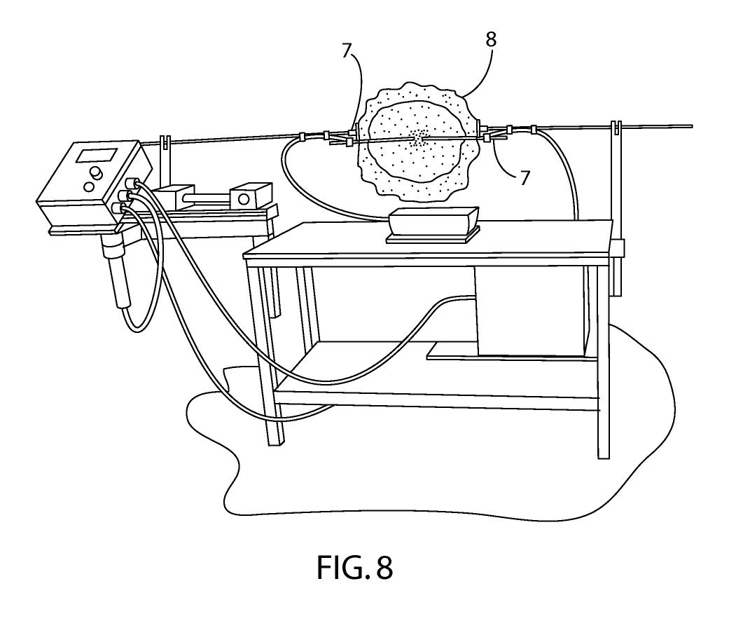

The electromagnetic coils 3 are wired either in parallel or in series with one another. The output of the coils 3 is wired through capacitors 6 (FIG. 4) that are connected in either series or parallel. The capacitors 6 tune the output of the electromagnetic coils 3 (inductance) depending on the desired results and smooth out the arc that is produced between electrodes 7 (see also FIGS. 7 and 8). The electrodes 7 may comprise various materials, preferably carbon and graphite. Also, electrodes 7 may comprise tungsten electrodes of the type used in heliarc welding processes.

With reference to FIG. 8, the arc 8 in open air produces an incandescent white light by burning the nitrogen and oxygen in the air. In a vacuum, the arc 8 would be invisible. The arc 8 has little heat due to there being a small amount of voltage (up to 200V), a small current (down to 10A) and a low frequency (up to 1 KHz). However, when material is introduced into the arc 8, the material can be heated to thousands of degrees and densify, vaporize or melt the material, or just heat it up to a desired temperature (e.g. for annealing), in seconds with very low energy input and very high output.

The present MEE 1 uses twenty four coils 3, twelve on each side of the rotor 4. The coils 3 may be connected in series or in parallel with one another. It is to be understood that more or fewer coils 3 can be used for different applications. The illustrated rotor 4 contains twenty four permanent magnets 2. Each magnet 2 is positioned so that it is opposite in polarity from the magnet 2 next to it. The magnets 2 can vary in power, more or less lines of flux, and other similar characteristics and types.

The coils 3 are wound to fit laminates 9. In the illustrated example, the laminates 9 comprise thin strips of steel or other conductive material that is wound in a circular ring-like roll. The use of layers of metal material prevents or reduces formation of magnetic eddy currents that could otherwise produce excessive heat. The conductive material may comprise virtually any material providing the necessary strength, heat resistance, electrical conductivity, formability, etc. The strips of conductive material may be adhesively and/or mechanically interconnected. The laminates 9 (stator) are in the form of a circle with twenty four risers 10 that are formed by machining the roll of metal material. It will be understood that other forms of laminates and materials may also be utilized. Every other riser 10 has a coil 3 on it, and the other twelve are blank. The blank risers 10 act as a magnetic return. The twelve risers 10 with the coils 3 thereon are called the acceptors. This causes the magnetic forces to swirl around or excite one another. As the rotor 4, with the north and south magnets, passes by the coils 3, each coil 3, one on each side of the rotor 4, gets excited and influences the other coils 3 wired in series. Both sides are wired in parallel or series depending on the desired results.

Coils 3 can be wound with large or small wire. The larger the wire, the less voltage and the less power. The smaller the wire, the more voltage, current and the more power. This can be done for different results. The coils 3 can be wound physically larger or smaller to achieve less or more power. All of these factors can be varied.

The low voltage and low current that excite the electrons in machine 1 have a greater energy range than a machine that produces similar electrons, such as a carbon arc furnace or an induction oven that takes 700A or more at 2,300 degrees Celsius.

In the embodiment illustrated in FIG. 2, the right hand electrode 7 is fixed relative to the worksurface, and the left hand electrode 7 is mounted for horizontal reciprocation on a mechanical drive 15 which accurately shifts electrodes 7 toward and away from each other in a horizontally aligned relationship. Alternatively, the electrodes 7 can be arranged in an angular relationship, such as a 30-60 degree included angle, and can also be used as a welder in conjunction with a grounded surface.

Magnetic electron exciter 1 is adapted to be used in conjunction with a wide variety of manufacturing processes and methods. In one working example of the present invention, mineral ore is positioned within the arc, which is adjusted to a predetermined intensity, so as to extract metallic components from the same. Other examples of processes incorporating the magnetic electron exciter 1 include melting or smelting precious metals. Magnetic electron exciter 1 purifies gold that is only 70 percent to 80 percent to 98 percent pure. Magnetic electron exciter 1 appears to vaporize impurities, leaving purified gold. Although the exact process is not known, magnetic electron exciter 1 melts and breaks down tailings of iron rock that cannot be melted, crushed, or drilled at present. Magnetic electron exciter 1 melts and purifies prill that has been extracted from ore. Other applications of magnetic electron exciter 1 will be apparent to those skilled in the art.

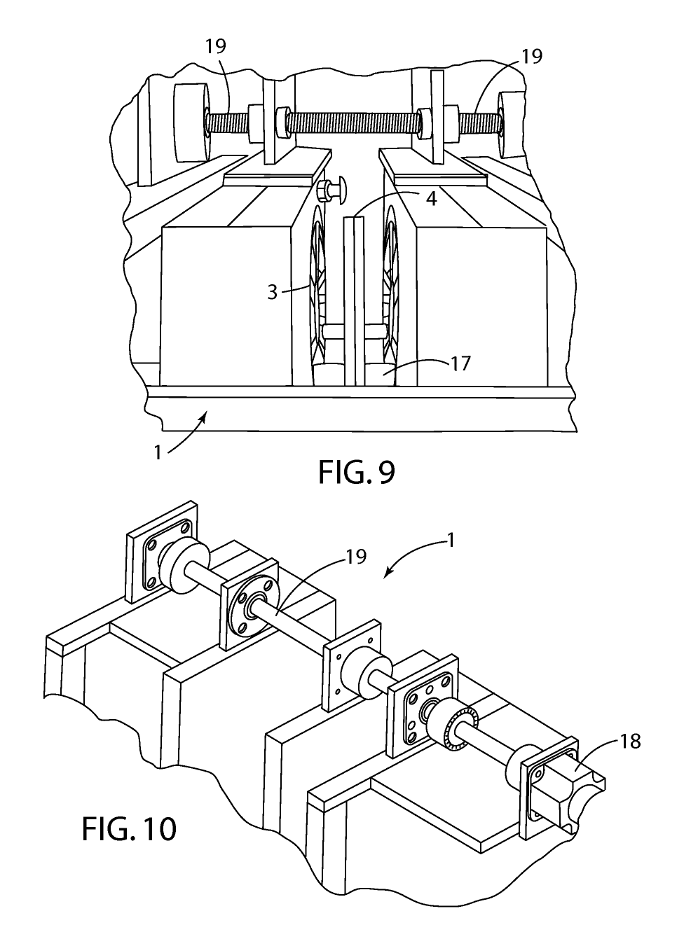

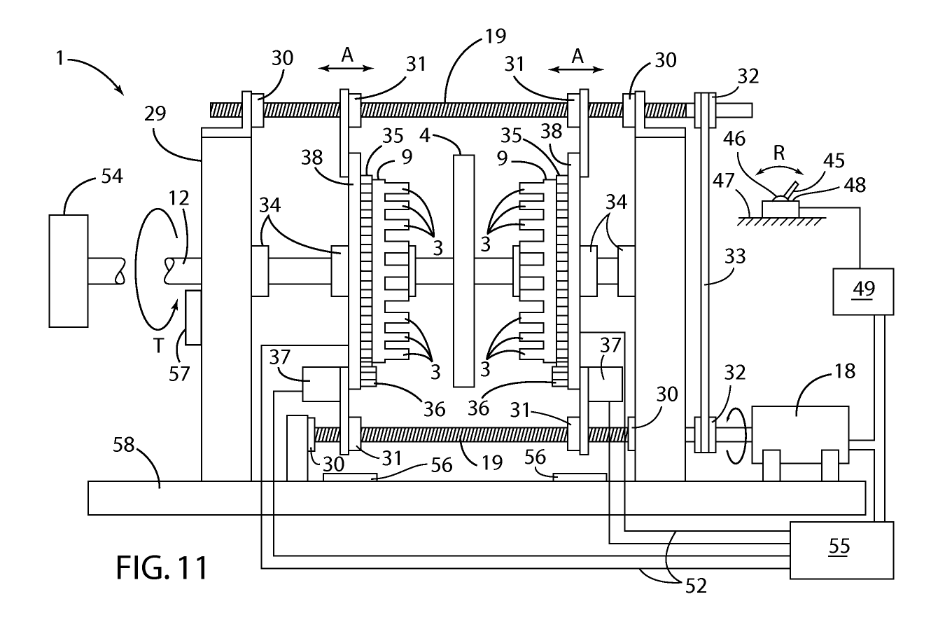

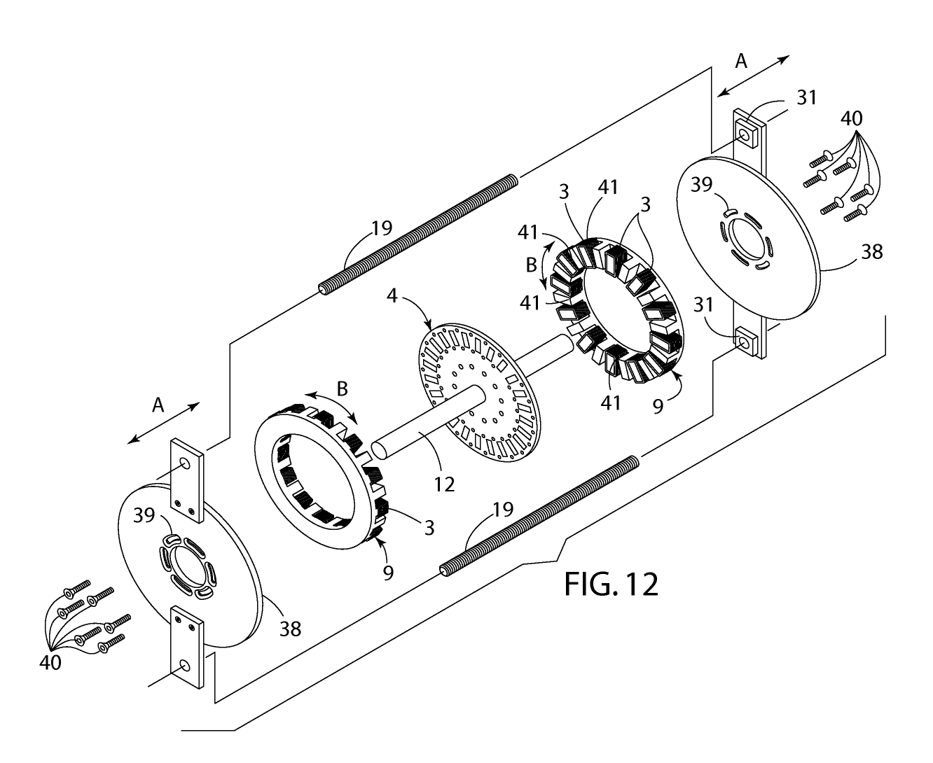

In the embodiment illustrated in FIGS. 9-12, laminates 9 are mounted on laterally adjustable supports or ways 17 which permit the laminates 9 to be horizontally converged and diverged as shown by arrows “A” (FIGS. 11, 12) relative to rotor 4 by actuating motor 18 to rotate screws 19, so as to facilitate adjusting the characteristics of the magnetic field applied to electrodes 7. Left and/or right-handed screws 19 can be used on the top and the bottom. In the embodiment of FIGS. 11 and 12, screws 19 are rotatably supported on a support structure by bearings 30, and drive nuts 31 cause stators 9 to shift towards and away from each other upon rotation of screws 19 by motor 18. Cogs 32 and chain 33 operably connect electric motor 18 to screws 19 to provide powered rotation of screws 19.

The power generated by the MEE, is quite substantial, even though the appearance of the arc can be relatively small. It takes less energy than a generator that produces 50 or 60 hertz. This arc could be much larger or could be used in a carbon arc furnace, such as in smelting plants or the like. The consumption of power is much less, but the power from the present MEE is many times more powerful.

The generator can be either an AC or DC generator that can produce many different voltages, such as 12 volt, 110 volt, 120 volt, 480 volt, 7200 volt, and up, either single phase and/or three phase, 50 to 1000 hertz and up. The MEE 1 can produce amperage from just a few to thousands of amps of current. An important part of the MEE 1 is the ability to eliminate or reduce the starting torque by moving the coils away from the rotor or the magnets when rotor 4 is first being rotated from a stationary state. Once the MEE 1 is started, it takes very little power to keep it running. This feature makes it quite useful in wind turbine applications, motor vehicles, and other similar machinery. It also makes it possible to control the amount of power by moving the coils closer or further apart.

By having coils 3/stators 9 on both sides of the rotor 4, it is possible to make two separate generators or motors. The two stators 9 on both sides can be connected together or separated. If the two stators 9 are wired separately, each side forms a separate generator. This may be utilized to provide redundancy. For example, if one generator fails with the outboard equipment, burns up, shorts out, gets hit by lightening, etc., the stators 9 of the damaged side may be moved away from the rotor 4 and magnets 2 by actuation of electric motor 18/screws 19 (FIGS. 9-12), and the stator 9/coils 3 on the other side could be moved closer to the rotor 4, or vice-versa. The other generator can then be used to prevent a long term shutdown. The coils 3 can be connected or disconnected by means of relays, switching devices, electronically, etc., to achieve different results. Thus, if device 1 is used as a generator with, for example, a wind turbine, one of the two generators can still be used even if the other generator fails. This ensures that the wind turbine continues to generate power even if one of the two generators fails.

The same MEE 1 or generator can also be used as an electric motor as discussed above. The principle of moving the coils 3 away from the rotor 4 and magnets 2 still applies. Thus, the output torque produced by MEE 1 for a given amount of electrical power supplied to device 1 can be adjusted by adjusting the positions of stators 9 relative to rotor 4. This movement eliminates or reduces the starting torque of the MEE. Some of the problems with electric motors for cars and other devices is the starting torque. This is also a problem encountered in wind turbines. Stators 9 may be moved away from rotor 4 to initially permit rotation of a wind turbine from a stopped configuration, and stators 9 may be moved towards rotor 4 at higher r.p.m. to provide increased output of electrical power. The positions of stators 9 relative to rotor 4 can also be utilized to control the power produced by device 1 when it is used as an electric motor for a car, train, bus, or other machines. Instead of a motor running the generator, a variable voltage device can drive the motor at different torques and speeds. As discussed in more detail below in connection with FIG. 12, the coils 3 may be rotationally adjusted such that they are offset from one another, rather than across from one another to thereby convert device 1 from a generator to a motor and visa-versa.

Also, existing generators typically provide different frequencies depending upon the r.p.m. of the generator. This can cause difficulties in applications such as wind turbines or the like where the turbine rotates at different speeds depending upon the wind speed. This makes it difficult to maintain a desired frequency such as 50 or 60 Hz.

The device 1 can be configured to provide a constant frequency regardless of the rotational rate of the wind turbine or other variable rpm power source. With reference to FIG. 11, stators 9 may be rotatably mounted to mounting plates 38 and/or shaft 12 by bearings 34. A gear 35 extends around the outside of each stator 9. Drive gears 36 of electric motors 37 engage gears 35 to thereby rotate stators 9 relative to mounting plates 38. Timing belts or other suitable devices may be utilized instead of gears 35 and 36 to operably interconnect stators 9 and electric motors 37 to provide for powered rotation of stators 9 relative to mounting plates 38. If an input torque “T” from a wind turbine or the like (not shown) varies in r.m.p., electric motors 37 can be utilized to rotate stators 9 to maintain a constant rpm relative to rotor 4 and thereby ensure that the electricity produced by the MEE 1 has a constant frequency. Restated, the difference in rotational velocity of the stators 9 relative to rotor 4 remains constant due to rotation of stators 9. As discussed above, the stators 9 can also be linearly shifted relative to rotor 4 in the direction of the arrows “A” by rotation of screws 19. Movement of the stators 9 relative to the disc 4 in the direction of arrows A changes the amount of torque required to rotate rotor 4. Accordingly, another way to ensure that the electrical power from MEE 1 has a constant frequency is to vary the position of the stators 9 relative to rotor 4 to increase or decrease the rotational force required to rotate rotor 4, thereby maintaining a relatively constant r.p.m. and Hz regardless of the magnitude of the input torque T. Also, if the power output of the MEE 1 must not exceed a certain level in a particular application, the stators 9 can be rotated utilizing motors 37 to reduce the output power.

With further reference to FIG. 12, mounting plates 38 may include a plurality of curved slots 39. A plurality of screws 40 may be inserted through curved slots 39, with screws 40 threadably engaging threaded openings (not shown) in stators 9 to thereby hold or clamp stators 9 on mounting plates 38. Screws 40 can be loosened to permit rotation and adjustment of mounting plates 38 as indicated by the arrows “B”. In this way, the relative positions of the coils 3 of one stator 9 can be changed relative to the coils 3 of the other stator. If the coils of the two stators 9 are axially aligned, the device 1 generates electricity and thereby acts as a generator. However, if the coils 3 of the stators 9 are not aligned whereby coils of each stator 9 are aligned with the areas 41 in between coils 3 of the other stator 9, the device 1 acts as an electric motor and produces electrical power if an input torque is applied to shaft 12 of rotor 4. It will be understood that the motors 37 and gears 35 and 36 (or other suitable powered drive arrangement) shown in FIG. 11 can also be utilized to rotate one or both of the stators 9 relative to the other of the two stators 9 to thereby change the operation of the device 1 of FIG. 11 from a generator to a motor and vice-versa.

As discussed above, the stators 9 and coils 3 can be moved axially towards and away from rotor 4 utilizing electric motor 18 (FIG. 11). In this way, the torque T required to rotate rotor 4 can be adjusted. The device 1 can act as a brake by adjustment of the position of rotors 9 relative to rotor 4. For example, a brake pedal 45 may be rotatably mounted for rotational movement as shown by arrow “R” relative to a support surface 47 about an axis 46. A sensor such as a potentiometer 48 may be operably connected to a controller 49 to provide a signal to controller 49 corresponding to a rotational position of pedal 45. Controller 49 provides a signal to motor 18 to shift stators 9 relative to rotor 4 to thereby adjust the resistance torque T based, at least in part, on the position of pedal 45. In use, the shaft 12 may be operably connected to a wheel 54 of a vehicle to thereby provide a brake function. It will be understood that a device 1 may be utilized at each wheel of a motor vehicle or the like. Sensors 56 may be utilized to measure the positions of stators 9 and generate a corresponding signal to controller 49. Sensors 56 are operably connected to controller 49 by electrical lines (not shown) or other suitable means. Also, motors 18 and 37 may include sensors providing the rotational velocity and/or position of the output shafts of the motors whereby the linear (arrow A) and rotational positions and/or velocities of the stators 9 can be determined by controller 49. Furthermore, one or more sensors 57 may be operably connected with controller 49 and provide a signal that may be utilized to determine the rotational position/velocity of shaft 12 and/or wheels 54. If device 1 is used as a brake for motor vehicles, base structure 58 may comprise a vehicle structural component. Although the rotating member 54 may comprise a wheel of a vehicle, it will be understood that rotating member 54 could comprise a wind turbine or other such device according to other aspects of the present invention. Also, the device 1 can be configured to act as a generator at the same time it is providing the braking function to thereby provide electrical power output to a vehicle battery 55 or the like.

Also, when device 1 is utilized as a brake, the stator 9 may be configured as a non-electronic brake without coils 3 (or coils 3 could be electrically disconnected) whereby the device 1 provides a braking force without generating electricity. In general, when the device is configured as a non-electronic brake without coils, it may be utilized in the same applications as when the device is used as a brake with coils, except that the device does not generate electricity when configured without coils. For example, motor 18 could be configured to move stators 9 in the directions of arrows A from a first position wherein stators 9 are positioned directly adjacent to rotor 4 to a second position wherein stators 9 are spaced apart from rotor 4. In the first position, the device provides a maximum or full braking force or torque T. In the second position, the device provides little or no braking force or torque T. Controller 49 may be configured to provide a range of positions between the first and second positions corresponding to the position of brake pedal 45 to provide a variable braking force.

In general, when the device is configured as a non-electronic brake (i.e. without coils), the magnets 2 could be positioned where the stators 9 are, and the metal and non-metal laminate could be positioned on the rotor 4 or visa-versa. By moving the magnets towards/away from the rotor/metal/laminate the device acts similar to the Electron Exciter version of the device described in more detail above. Also, if the device is configured as a non-electronic brake, coils 3 are not utilized or required, and stators/laminates 9 may therefore comprise rings without risers 10.

It will be understood that other parameters may be utilized to control the motor 18 and positions of stators 9 and resulting braking torque T. For example, device 1 may be configured to control the speed of presses or other industrial machines based on a maximum or optimal speed. Also, the device may be utilized to brake other machinery or devices such as wind turbines or the like based upon a sensed r.p.m., power output, temperature, or other suitable control parameter.

As discussed above, in the illustrated example the device 1 includes a total of 24 coils 3, with each stator 9 having 12 coils. In use, the number of coils 9 that are electrically connected to electrical output lines 52 can be changed to increase or decrease the amount of power generated by device 1. Furthermore, as discussed above, the device may also be configured as a brake without coils.

Another important aspect of the present invention is a generator or motor that can be used as a non-contact brake. By using different materials on the rotor with the magnets, this forms a different magnetic field that tends to stop the rotor when the coils are moved in closer to the rotor. It is possible in automobiles and other vehicles to eliminate or assist friction-based mechanical brakes to thereby alleviate or eliminate wear that occurs in contact-type brakes. This is a substantial problem with wind turbines that use friction brakes to control or regulate the movement of the rotor. Hence, the MEE or generator can be used on machines of all types, such as pumps, presses, etc. In using the MEE as a brake, rather than outputting to the energy to an arc, as normally done, the output can be routed to a battery charger or generator to achieve a quick charge. In a wind baking turbine application, the MEE, when used as a brake, can also generate power as it is braking the turbine.

MEEs or generators using ferrite magnets in the rotor require a smaller gap between the coils and magnets. Using neodymium magnets, the gap can be larger and therefore not so critical.

The present generator is different than the devices disclosed in the Kranz U.S. Pat. No. 2,026,474, the Gilbreth U.S. Pat. No. 6,023,135 and the Voronin U.S. Pat. No. 4,931,702. More specifically, the present generator is designed to produce varying frequencies that have a different effect on various materials. Low frequencies have a different effect on the certain materials than high frequencies.

The present arc is a cold arc with low voltages 0 to 80 volts, and current in the range of 0 to 80 amps. The arc produced is more powerful than a 1,000 amp welder operating to 60 Hz. By varying the speed of the rotor and/or the number of magnets and/or coils, the machine will produce higher or lower frequencies. By varying the air gap between the rotor containing the magnets and the coils, the power of the arc is made variable. This also is a factor on various materials for treating, melting, separating, or vaporizing undesired dross from various materials.

The present arc is also varied by using electrodes that can be fed differing inert gases, such as argon and helium, as well as CO₂, acetylene, etc. This also produces a different effect on various materials as well as varying the spark gap.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. An electromagnetic braking system, comprising:
a support structure;
a rotor that is rotatably mounted to the support structure for rotation about an axis, the rotor including a plurality of magnets that are radially spaced from the axis;
a powered actuator;
at least one stator including a plurality of conductive coils positioned adjacent the rotor whereby the rotor has a resistance torque tending to reduce a rotational velocity of the rotor, and wherein the stator is operably interconnected to the support structure such that actuation of the powered actuator causes the stator to move along the axis to thereby change a position of the stator relative to the rotor and thereby change the resistance torque required to rotate the rotor;
a controller that is operably connected to the powered actuator;
an input sensor configured to provide an input signal corresponding to a position of an input member capable of being manipulated by an operator, and wherein the controller causes the actuator to position the stator relative to the rotor based, at least in part, on the input signal.

2. The electromagnetic braking system of claim 1, wherein:
the one stator comprises a pair of stators positioned on opposite sides of the rotor.

3. The electromagnetic braking system of claim 2, including:
a brake pedal for a motor vehicle; and wherein
the input sensor determines a position of the brake pedal.

4. The electromagnetic braking system of claim 1, wherein:
the powered actuator comprises an electric motor.

5. The electromagnetic braking system of claim 4, wherein:
the powered actuator is operably interconnected with the one stator by an elongated screw that is operably connected to the electric motor.

6. The electromagnetic braking system of claim 1, wherein:
the one stator is rotatably connected to the support structure; and including:
a second powered actuator operably connected to the one stator and rotating the stator about the axis.

7. The electromagnetic braking system of claim 6, wherein:
the second powered actuator is operably connected to the controller, and wherein the controller is configured to rotate the one stator to maintain a preselected frequency of electrical power generated by the electromagnetic braking system.

8. The electromagnetic braking system of claim 6, wherein:
the second powered actuator is operably connected to the controller, and wherein the controller is configured to rotate the stator to ensure that electrical power generated by the electromagnetic braking system does not exceed a predetermined amount.

9. The electromagnetic braking system of claim 6, wherein:
the second powered actuator is operably connected to the controller, and wherein the controller is configured to rotate the stator to maintain an rpm of the rotor within a preselected range.

10. A non-contact brake, comprising:
a support structure;
a rotor rotatably mounted to the support structure whereby the rotor is adapted to be rotated within a selected range of rotational speeds by the drive shaft of a machine;
a plurality of magnets mounted to the rotor at selected distances from the rotational axis of the rotor;
a plurality of coils disposed adjacent to the rotor at a variable distance from the rotor, whereby a braking torque tending to slow rotation of the rotor is produced upon rotation of the rotor; and wherein:
the variable distance can be adjusted to thereby adjust a magnitude of the braking torque.

11. The non-contact brake of claim 10, wherein:
the plurality of magnets are mounted to a stator structure, and including:
a linear slide movably interconnecting the stator structure and the support structure for linear movement of the stator structure in a direction parallel to the rotational axis of the rotor.

12. The non-contact brake of claim 11, including:
a powered actuator operably connected to the stator structure and providing reciprocating powered movement of the stator structure relative to the support structure.

13. The non-contact brake of claim 12, including:
a controller;
an input member configured to be moved by an operator between a plurality of positions;
a sensor configured to provide a signal to the controller corresponding to a position of the input member; and wherein:
the controller is configured to selectively actuate the powered actuator to control a position of the stator structure relative to the support structure based, as least in part, on a position of the input member.

14. The non-contact brake of claim 13, wherein:
the input member comprises a brake pedal of a motor vehicle; and:
the rotor is adapted to be operably connected to at least one wheel of a motor vehicle.

15. The non-contact brake of claim 14, including:
a vehicle electrical system comprising at least one battery; and wherein:
the coils are electrically connected to the vehicle electrical system to thereby provide electrical power to the vehicle electrical system when a braking torque is being produced.

16. An electrical device, comprising:
a support structure;
a first component rotatably mounted to the support structure for rotation about an axis, the first component including a plurality of magnets spaced about the axis; and wherein:
a pair of second components that are movable relative to the first component to define first and second variable distances between the first component and the second components, wherein second components comprise electrically conductive material;
an actuator operably connected to at least a selected one of the first component and pair of second components to selectively change the distances between the first component and the second components upon actuation of the actuator;
whereby actuation of the actuator selectively changes the distances between the first component and the second components to vary at least a selected one of a torque produced by the first component if electrical power is supplied to the device, and a torque required to rotate the first component relative to the second components.

17. The electrical device of claim 16, wherein:
the actuator comprises a powered actuator.

18. The electrical device of claim 17, wherein:
the powered actuator comprises an electric motor that selectively shifts the second components in a direction parallel to the axis.

19. The electrical device of claim 16, wherein:
the second components are mounted to linear guides whereby the second components move parallel to the axis upon actuation of the actuator.

20. The electrical device of claim 19, wherein:
the second components are rotatably mounted to the support structure for rotation about the axis.

21. The electrical device of claim 20, including:
A powered actuator operably connected to the second components to thereby provide powered rotation of the second components relative to the first component.

22. The electrical device of claim 16, wherein:
each second component includes a plurality of electrically conductive coils.

23. The electrical device of claim 22, including:
the electrically conductive coils of the second components can be axially aligned to configure the device as a generator that produces electrical power upon rotation of the first component.

24. The electrical device of claim 23, wherein:
the coils of a selected one of the second components can be moved relative to the coils of the other of the second components to a position wherein the coils of the one second component are not axially aligned with the coils of the other of the second components whereby the device generates a torque if electrical power is supplied to at least a selected ones of the coils.

25. The electrical device of claim 16, including:
a sensor configured to sense an operating parameter of a motor vehicle;
a controller operably connected to the sensor; and wherein:
the first component is adapted to be operably interconnected to a wheel of a motor vehicle;
the actuator comprises a powered actuator;
the controller is configured to utilize an input from the sensor to selectively actuate the powered actuator to thereby change the distances between the first component and the second components and change a force required to rotate the first component whereby the device is capable of providing a braking force for a motor vehicle.
